(19) United States
(12) Patent Application Publication
(10) Pub. No.: US 2004/0155855 A1
(43) Pub. Date: Aug. 12, 2004

(54) Method and circuit for dynamic gamma adjustment of liquid crystal display and driving circuit of liquid crystal display panel

(76) Inventor: Chien-Jen Chang, Hsinchu (TW)

Correspondence Address: FISH & RICHARDSON PC, 225 FRANKLIN ST, BOSTON, MA, 02110, US

(21) Appl. No.: 10/764,241

(22) Filed: Jan. 23, 2004

(30) Foreign Application Priority Data
Feb. 7, 2003 (TW) 92102486

(51) Int. Cl. G09G 3/36

(52) U.S. Cl. 345/102

(57) ABSTRACT

A circuit for dynamic gamma adjustment of an LCD having a data driver and a gate driver. The brightness sampling circuit detects a brightness data of a data signal provided to the data driver. The brightness classifying circuit classifies the brightness data as a predetermined brightness group. The gamma decision circuit provides a predetermined gamma signal of a predetermined brightness group to the data driver.

### BACKGROUND OF THE INVENTION

The present invention relates in general to a method and a circuit for dynamic gamma adjustment of a liquid crystal display (LCD). In particular, the present invention relates to a method and a circuit for dynamic gamma adjustment of an LCD according to the displayed image during image display.

### DESCRIPTION OF THE RELATED ART

Gamma is adjusted to improve the display effect when driving the LCD panel. Gamma value influences the color tones and gray levels of a display. In addition, the brightness of a predetermined gray level of the display is adjusted by changing the gamma setting of a display to improve the display effect. For example, the brightness of a predetermined gray level of the display is increased when the gamma value is increased. Alternately, the brightness of a predetermined gray level of the display is decreased when the gamma value is decreased. Thus, the quality of a displayed image is adjusted by changing the gamma setting.

In a conventional LCD, gamma value is set by the manufacturer according the characteristics of the liquid crystals to achieve an optimal setting. In addition, the gamma value of the display is adjusted by the manufacturer before leaving the factory or by a user during setup of the display. However, the gray levels of a portion of the display are not apparent when the gamma setting does not fit within the displayed frame. Thus, the quality of the display effect is reduced. In addition, when an animation requiring a large number of frames to be displayed, different gamma settings are required to distribute gray-levels of different brightness. Thus, the conventional gamma setting with a fixed value does not adequately provide brighter and darker frames at the same time.

### SUMMARY OF THE INVENTION

The object of the present invention is thus to provide a method and a circuit for dynamic gamma adjustment of an LCD while the images are displayed according to the display parameters of the displayed images. Thus, the gamma setting is adjusted according to the display parameters of the displayed image to prevent the default gamma value which may not be suitable for the present displayed image. The present invention classifies the input image data first as a plurality of brightness levels corresponding to different gamma settings. Next, a decision circuit selects a suitable gamma setting according to the classified image data, and inputs the data to an LCD driving circuit, thus driving the LCD to obtain optimal image quality. The resolution of the dark area of the display is increased in a dark frame and of the bright area of the display is increased in a bright frame by adjusting the gamma setting. Here, the classification the input image data and the number of gamma settings are defined by the designer. The method of sampling the display brightness can be sampling a single frame, several frames, or a portion of the frame.

To achieve the above-mentioned object, the present invention provides a method for dynamic gamma adjustment of an LCD having a data driver and a gate driver. First, brightness data of a data signal provided to the data driver is detected. Next, a gamma signal is provided to the data driver according to the brightness data.

In addition, the present invention provides a circuit for dynamic gamma adjustment of an LCD having a data driver and a gate driver. The brightness sampling circuit detects a brightness data of a data signal provided to the data driver. The brightness classifying circuit classifies the brightness data to a predetermined brightness group. The gamma decision circuit provides a predetermined gamma signal of a predetermined brightness group to the data driver.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a schematic diagram of an LCD panel and the peripheral driving circuits thereof according to the embodiment of the present invention.

### DETAILED DESCRIPTION OF THE INVENTION

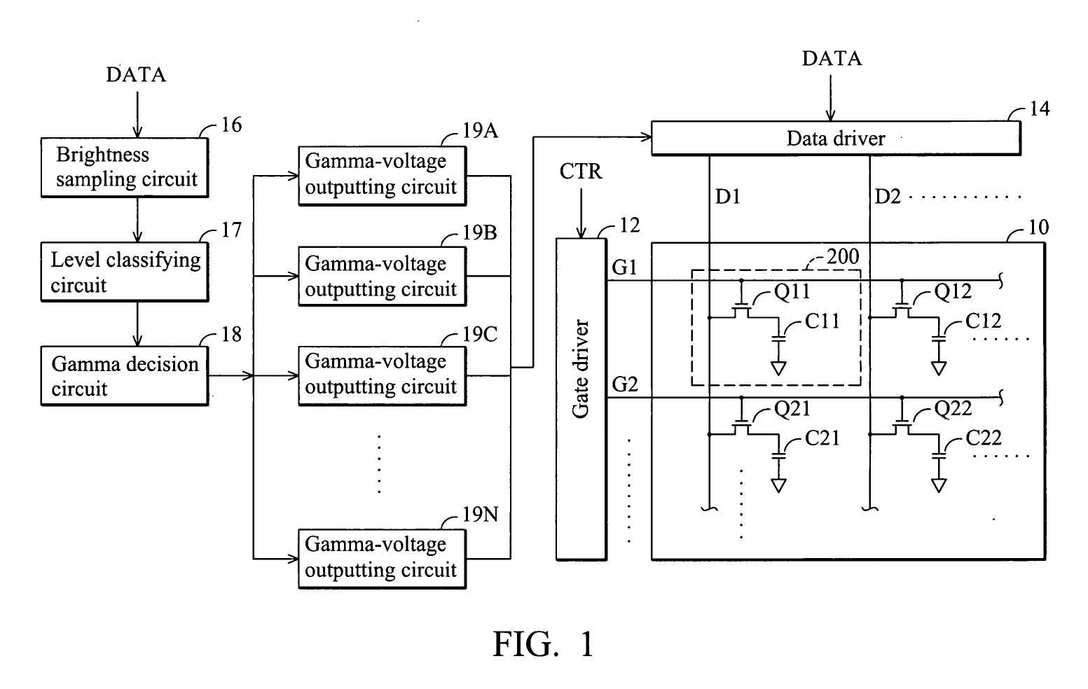

FIG. 1 is a schematic diagram of an LCD panel and the peripheral driving circuits thereof according to the embodiment of the present invention. As shown in the figure, a LCD panel 10 is formed by interlaced data electrodes (represented by D1 and D2 . . . ) and gate electrodes (represented by G1 and G2 . . . ), each of the interlaced data electrodes and gate electrodes controlling a display unit 200. As an example, the interlaced data electrode D1 and gate electrode G1 control the display unit 200. The equivalent circuit of each display unit comprises thin film transistors (TFTs) (Q11, Q12, Q21 and Q22 . . . ) and storage capacitors (C11, C12, C21, C22, . . . ). The label VCOM represents the reference voltage of each display unit. The gates and drains of these TFTs are respectively connected to gate electrodes and data electrodes. A connection of this type can simultaneously activate and deactivate all the TFTs positioned on the same scan line using a scan signal of the gate electrodes, thereby controlling the video signals of the data electrodes to be written into the corresponding display unit. It is noted that a display unit only controls the brightness of a single pixel on the LCD panel.

Accordingly, each display unit responds to a single pixel on a monochromatic LCD while each display unit responds to a single subpixel on a color LCD. The subpixel can be red (represented by “R”), blue (represented by “B”), or green (represented by “R”). In other words, a single pixel is formed by an RGB (three display units) combination.

In addition, FIG. 1 also shows a part of the driving circuit of the LCD panel 10. Gate driver 12 outputs one or more scan signals (also referred to as scan pulses) of each of the gate electrodes according to a predetermined sequence. When a scan signal is carried on one gate electrode, the TFTs within all display units on the same row or scan line are activated while the TFTs within all display units on other rows or scan lines may be deactivated. When a scan line is selected, the data driver 14 outputs a video signal (gray value) to the display units of the respective rows through data electrodes according to the image data to be displayed. After the gate driver 12 scans n rows continuously, the display of a single frame is completed. Thus, repeated scans of each scan line can achieve the purpose of continuously displaying an image. As shown in FIG. 1, signal CTR indicates the scan control signal received by the gate driver 12 and signal DATA indicates the data signal output by a host to display images.

The data signal DATA is input to the data driver 14 for driving the LCD panel 10 and a brightness sampling circuit 16. The brightness sampling circuit 16 obtains the brightness information of the present frame according to the received data signal DATA. Here, the data signal DATA is a digital signal recording related brightness information. The brightness information includes the gray-level distribution of a single frame or a plurality of frames. The brightness of the frame is obtained according to the gray-level distribution. In addition, the data sampled by the brightness sampling circuit 16 may include the information about the mean-brightness of a single frame or a plurality of frames, or a portion of a single frame.

The level classifying circuit 17 classifies the sampled data signals according to the brightness information obtained by the brightness sampling circuit 16 to several gray level groups. Thus, the brightness of single or a plurality of frames in predetermined gray levels is determined to be too bright or too dark.

The gamma decision circuit 18 selects one of the gamma-voltage outputting circuits 19A˜19N according to the gray level groups of the sampled frames obtained by the level classifying circuit 17. The gamma-voltage outputting circuits 19A˜19N output different gamma data in response to different gray levels to the data driver 14 to adjust the brightness of a predetermined gray level. For example, when the brightness of the frames is too dark in a predetermined gray level, the gamma decision circuit 18 selects the gamma-voltage outputting circuit and increases the voltage or current of the data electrodes related to the display of the predetermined gray level to improve the resolution of low gray level. When the brightness of the frames is too bright in another predetermined gray level, the gamma decision circuit 18 selects the gamma-voltage outputting circuit and decreases the voltage or current of the data electrodes related to the display of the predetermined gray level to improve the resolution of high gray level.

Accordingly, the present invention provides a method and a circuit for dynamic gamma adjustment of an LCD while the images are displaying according to the display parameters of the displayed images. Thus, the gamma setting is adjusted according to the display parameters of the displayed images to prevent the default gamma value which may not be suitable for the present displayed image. The present invention classifies the input image data as a plurality of brightness levels corresponding to different gamma settings. Next, a decision circuit selects a suitable gamma setting according to the classified image data to a LCD driving circuit to drive the LCD to obtain optimal resolution. Thus, the gamma setting is changed according to the detected display during displaying. Therefore, the disadvantage of the fixed gamma setting of the conventional display unable to conform to the variable brightness of different frames is solved. In addition, the present invention not only applies LCDs, but also others types of displays, such as plasma displays.

The resolution of the dark area of the display is increased in a dark frame and the bright area of the display is increased in a bright frame by adjusting the gamma setting in response to the brightness of the display. Here, the classification the input image data and the numbers of the gamma settings are defined by the designer. The ways of sampling of the display brightness can by sampling single frame, several frames, or a portion of the frame.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for dynamic gamma adjustment of an LCD having a data driver and a gate driver, comprising the following steps:
detecting a brightness data of a data signal provided by the data driver; and
providing a gamma signal according to the brightness data to the data driver.

2. The method as claimed in claim 1, wherein the brightness data represents a gray-level distribution of a single frame.

3. The method as claimed in claim 1, wherein the brightness data represents an average gray-level distribution of a plurality of frames.

4. The method as claimed in claim 1, wherein the gamma signal enhances the brightness resolution of a low gray level when the brightness data belongs to a low gray level.

5. The method as claimed in claim 1, wherein the gamma signal enhances the brightness resolution of a high gray level when the brightness data belongs to a high gray level.

6. The method as claimed in claim 1, wherein the gamma signal adjusts a voltage level of the data signal presenting a predetermined gray level.

7. The method as claimed in claim 1, wherein the data signal is a digital signal.

8. A circuit for dynamic gamma adjustment of an LCD having a data driver and a gate driver, comprising:
a brightness sampling circuit for detecting a brightness data of a data signal provided by the data driver;
a brightness classifying circuit for classifying the brightness data into a predetermined brightness group; and
a gamma decision circuit for providing a predetermined gamma signal of the predetermined brightness group to the data driver.

9. The circuit as claimed in claim 8, wherein the data signal is a digital signal.

10. The circuit as claimed in claim 9, wherein the brightness sampling circuit obtains the brightness data by analyzing the digital signal.

11. The circuit as claimed in claim 8, wherein the brightness data represents a gray-level distribution of a single frame.

12. The circuit as claimed in claim 8, wherein the brightness data represents an average gray-level distribution of a plurality of frames.

13. The circuit as claimed in claim 8, wherein the gamma signal output by the gamma decision circuit enhances the brightness resolution of a low gray level when the brightness data belongs to a low gray level.

14. The circuit as claimed in claim 8, wherein the gamma signal output by the gamma decision circuit enhances the brightness resolution of a high gray level when the brightness data belongs to a high gray level.

15. The circuit as claimed in claim 8, wherein the gamma signal output by the gamma decision circuit adjusts a voltage level of the data signal presenting a predetermined gray level.
